(19) United States
(12) Patent Application Publication
(10) Pub. No.: US 2015/0321076 A1
(43) Pub. Date: Nov. 12, 2015

(54) Saigon Five Card

(71) Applicant: TANG DYNASTY ENTERTAINMENT, LLC., Egg Harbor Township, NJ (US)

(72) Inventor: Jonathan L Tang, Egg Harbor Township, NJ (US)

(21) Appl. No.: 14/270,431

(22) Filed: May 6, 2014

(51) Int. Cl. A63F 1/00; G07F 17/32

(52) U.S. Cl. CPC A63F 1/00; G07F 17/3293; G07F 17/3276; A63F 2001/005

(57) ABSTRACT

A method for playing a card game using a single 53-card deck, consisting of the usual 52 cards, plus one joker where players attempt to defeat the banker (who may be the casino dealer, or one of the other players at the table). Players and the dealer are dealt five cards apiece. The player will separate his five cards into a three-card qualifying hand, and two-card showdown hand. The three-card qualifying hand must meet the qualifying requirement of having the values of the cards selected add up to a total sum equals to 10, 20 or 30. If player and the dealer each held a qualifying hand that meets the qualifying requirement, compare player's showdown hand ranking with dealer's showdown hand ranking. The showdown hand, have the highest ranking, won the hand. The joker can be used to represent three (3), six (6) or nine (9) value card on the three-card qualifying hand or two-card showdown hand. One variation of the game is to treat all five cards dealt as a bonus hand where a player makes a bonus bet that the five cards dealt will attain one of a predetermined standard poker hands. The joker can be used on the bonus hand to represent a card to complete a royal flush, straight flush or straight or as an Ace to attain 5 Aces, 4 Aces (Four of A Kind), 3 Aces (Three of A Kind) or 2 Aces hand. Another variation of the game is to provide a side pot bet wagering option where all players contribute to the side pot and the player having the best hand wins the side pot.

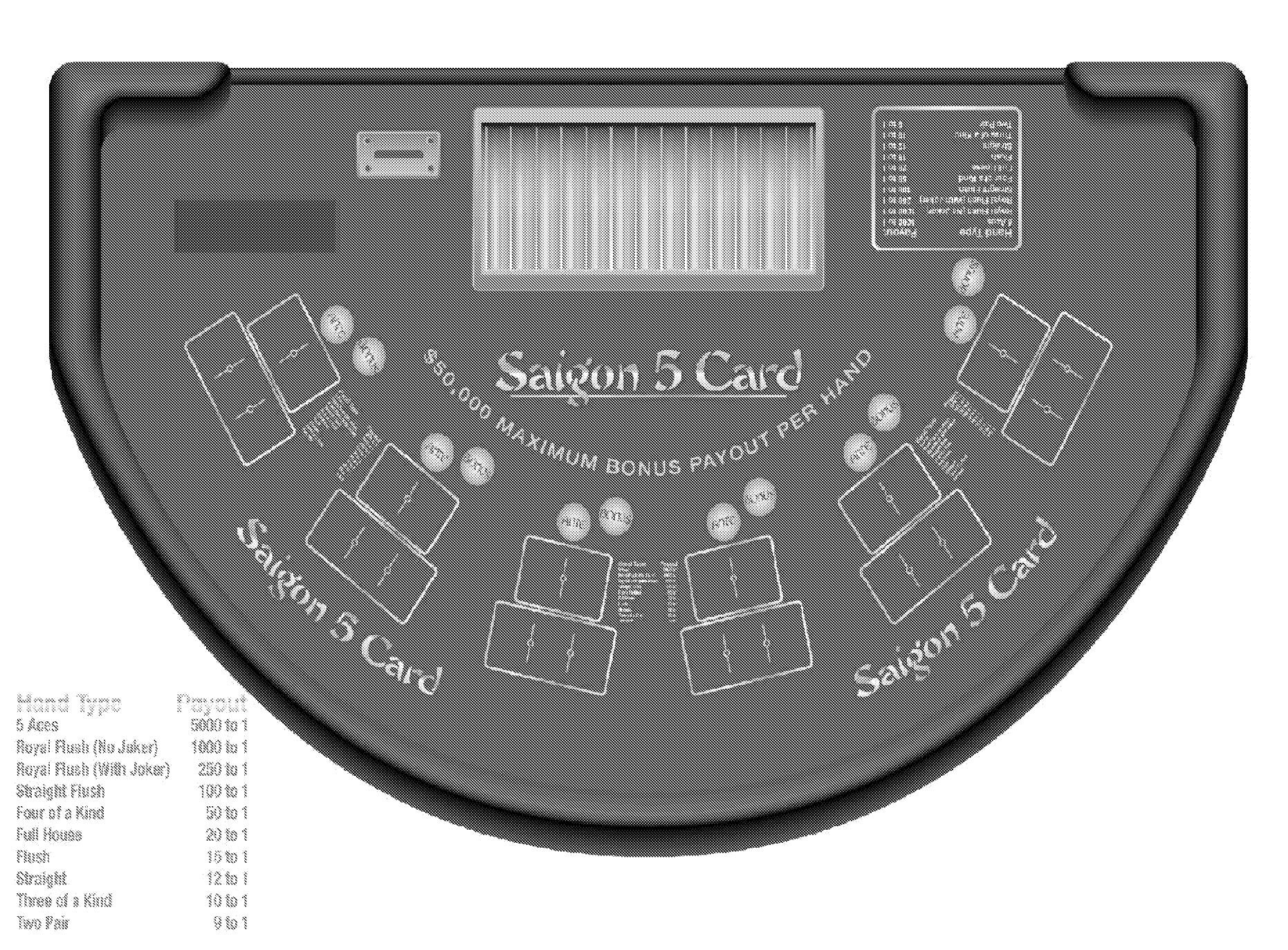

### FIELD OF THE INVENTION

The invention relates to the card game. More particularly, the invention relates to card-type games suitable for casino operators and other gaming environments. As used herein, The term “card” is used in the present application to indicate a playing card or any facsimile thereof. For example, a card can be a paper playing card or an image of a card on a video display. Any representation of a card is contemplated. The term “card game”, is intended to include conventional table/board type games wherein one or more persons deal actual playing cards to one or more players, as well as any type of mechanical or electronic device which displays indicia of playing cards. Thus, the card game may be played as a live table card game, a video card game, or other computer format card game (e.g., over the Internet).

### BACKGROUND OF THE INVENTION

Casinos and gaming establishments continually require new games to offer their clientele. Players typically enjoy games which are easy to understand, and which offer players a plurality of choices and thrill of higher jackpots. A plurality of wagering options and higher jackpots heightens player interest in the game. It would therefore be desirable to provide card game having multiple wagering options and higher jackpot, and which can be practiced on existing casino tables and thus provides casino operators with additional revenue generating features.

### SUMMARY OF THE INVENTION

Therefore, it is an object of the present invention to provide a card game that is easy to understand and has many features of an exciting gambling game. The game can be enjoyed by all classes of players, including novices and less experienced players because there is a large element of luck involved. A beginner has a good chance of winning in the short term, even against experienced opponents.

Another object of this invention is to provide such a card game which would heighten player interest by offering multiple wagering options and higher jackpots.

Still another object of this invention is to provide such a card game which can be practiced on existing casino tables without requiring extra casino tables, space, or game surveillance, and which can provide casino operators with additional revenue generating features.

Accordingly, a card game is provided, utilizing a standard deck of playing cards (52 cards) and one joker. The Joker universality is limited: it can only be used to represent a card having a value of three (3), six (6) or nine (9) on three-cards qualifying hand and two-cards showdown hand. After players make a bet, the dealer deals each player and himself five cards. Players and dealer then has to arrange their five cards into a three-cards qualifying hand, and a two-card showdown hand. After the cards are arranged, the hands of the player and the dealer are mutually compared. At first, player-dealer three-cards qualifying hands are compared to see whether either hand meets the qualifying requirement of having the values of the cards selected add up to a total sum equals to one of a predetermined qualification numbers. If neither player nor dealer's qualifying hand meets the qualification of adding up to the predetermined value, then the bet shall push. If the player-dealer qualifying hands, both meet the qualifying requirement, then the player-dealer showdown hands will be compared and the hand having the highest total points ranking win the bet. If dealer qualifying hands meet the qualification and player not, then the player loses the bet. On the other hand, if the player qualifying hand meets the qualification and the dealer not, the player will receive even money only when the remaining two cards do not add up to a predetermined total points ranking. The player will win half of the bet if the sum of the remaining two cards does add up to the predetermined total point ranking.

Optionally, a bonus bet may be played as an adjunct to the regular game. The bonus bet is won when the five cards dealt matches one of a plurality of poker hand posted on the playing surface. The Joker universality is also limited on the bonus bet: it can be used only to represent a card to complete a royal flush, straight flush or straight. It also can be used to represent only as an Ace to attain 5 Aces, 4 Aces (Four of A Kind), 3 Aces (Three of A Kind) or 2 Aces hand.

A side pot is also contemplated that may be played as an adjunct to the regular game with or without the bonus bet. All players contribute to the side pot and the player having the best hand wins the side pot.

A tie hands bet is further contemplated that may be played as an adjunct to the regular game with or without the bonus bet and/or side pot. The tie hands bet is won by the player when the player and dealer's showdown hand each attain the same total points ranking. The tie hands bet shall push if both player and dealer qualifying hands fail to meet the qualifying requirement.

### BRIEF DESCRIPTION OF THE DRAWING

The FIGURE illustrates a top view of the inventive playing surface (layout) of a casino-type table with exemplary poker hands and corresponding payout odds for resolving the bonus bet in accordance with the invention.

### DETAILED DESCRIPTION OF THE PREFERRED EMBODIMENTS

The game is played with one Deck of playing cards (52 cards) and one joker. After players make a bet, the dealer will deal the players and himself five cards each. The players will separate their five cards into a three-card qualifying hand, and a two-card showdown hand. The three-card qualifying hand must add up to a total value of 10, 20 or 30 in order for player-dealer showdown hand competes to win the bet. The joker universality is limited and can only be used to represent a card having a value of three (3), six (6) or nine (9) on the three-card hand or two-card hand. In the event that neither the player nor the dealer's qualifying hand meets the qualifying requirement of adding up to a total value of 10, 20 or 30, then the bet shall push in which case neither player nor the dealer wins the bet or wager. If the dealer's qualifying hand meets the qualifying requirement of adding up to a total value of 10, 20 or 30 and the player qualifying hand fails to meet the qualifying requirement, then the dealer wins the bet. On the other hand, if the player qualifying hand meets the qualifying requirement and the dealer's qualifying hand fails to meet the qualifying requirement, the player will receive even money only when the remaining two cards do not add up to a total value of 5. The player will win half of the bet if the remaining two cards do add up to a total value of 5. If the player-dealer qualifying hands, both meet the qualifying requirement of adding up to a total value of 10, 20 or 30, then the player-dealer showdown hands will be compared for the highest total points ranking of the remaining two cards. The total points rankings of the remaining two cards ranged from one to ten, with ten being the highest. The showdown hand, having the highest total points ranking win the bet.

The card value point(s) and showdown hand total points rankings are listed below:

| Card Values | Point(s) |
|---|---|
| Ace card | =1 point |
| 2 card | =2 points |
| 3 card | =3 points |
| 4 card | =4 points |
| 5 card | =5 points |
| 6 card | =6 points |
| 7 card | =7 points |
| 8 card | =8 points |
| 9 card | =9 points |
| 10 card (Jack, Queen, and King) | =10 points |
| Sum of the Two-Cards | Showdown Hand Total Points |
| (Showdown Hand) values | rankings (1= lowest and 10 = highest) |
| 11 points (Ace, 10 card value) | =1 |
| 12 points | =2 |
| 13 points | =3 |
| 14 points | =4 |
| 15 points | =5 |
| 16 points | =6 |
| 17 points | =7 |
| 18 points | =8 |
| 19 points | =9 |
| 20 points | =10 |
| 21 points | =1 |
| 22 points | =2 |
| 23 points | =3 |

There are a number of optional variations which may be combined as desired. The use of three cards for qualifying hand and two cards for showdown hand are merely a convenience. However, other number of cards are contemplated for qualifying hand and showdown hand combinations. For example, it is contemplated that combinations such as four cards qualifying hand and two cards showdown hand, five cards qualifying hand and two cards showdown hand, four cards qualifying hand and three cards showdown hand may be used. To qualify, the sum of the four cards that constitute player's qualifying hand must add up to 10, 20, 30 or 40; and for five cards player's qualifying hand, it must add up to 10, 20, 30, 40 or 50. The total points rankings for the two cards showdown hand and three cards showdown hand remain the same, ten being the highest and 1 is the lowest. The total points rankings for the showdown hand is merely a convenience and is not limited in this respect and can vary as desired.

Optionally, a bonus bet may be played as an adjunct to the regular game. In addition to the regular bet placed on the designated ANTE placement circle on the playing surface, Players may optionally place a separate wager in the designated BONUS placement circle on the playing surface to bet on the five cards dealt to attain one of a predetermined poker hands shown on the playing surface with or without the presence of joker card. Regular bet hand and bonus bet hand, are played separately. The player automatically receives the bonus payouts listed on the playing surface for attaining a posted bonus hand on the playing surface. The amount of payouts for the bonus bet is typically determined by the odds of getting a particular poker hand. There are several ways to determine how much is paid out for a particular hand. In the preferred payouts listed below, the player receives a set multiple of the amount that the player originally wagered. For example, if a player gets a full house, he receives 20 times the amount that he wagered. The universality of the Joker is limited on the bonus bet: it can be used only to represent a card to complete a royal flush, straight flush or straight. It also can be used to represent only as an Ace to attain 5 Aces, 4 Aces (Four of A Kind), 3 Aces (Three of A Kind) or 2 Aces hand.

Bonus Bet Payout Schedule

| Poker hand rankings | Multiples of player wager |
|---|---|
| 5 Aces | 5000 to 1 |
| Royal Flush (No Joker) | 1000 to 1 |
| Royal Flush (With Joker) | 250 to 1 |
| Straight Flush | 100 to 1 |
| Four of a kind | 50 to 1 |
| Full house | 20 to 1 |
| Flush | 15 to 1 |
| Straight | 12 to 1 |
| Three of a kind | 10 to 1 |
| Two pair | 9 to 1 |

Maximum payout $ 50,000 per hand.
Minimum Dollar Bet = $1
Maximum Dollar Bet = $100

There are a number of optional enhancements which may be combined as desired. The use of standard poker rankings to determine the payouts in the bonus bet is merely a convenience. It is used primarily because most people know the rankings and know that it is more difficult to get a straight than to get a pair. However, other card combinations are contemplated for determining payouts, for example, a hand of all even/odd numbered cards or a hand with at least one card from each suit.

Another variation of the game is to create a side pot where all players contribute to the side pot and the player having the best hand wins the side pot.

Optionally, a Tie Hands bet may also be played as an adjunct to the regular game. In addition to the regular bet placed on the designated ANTE placement circle on the playing surface, Players may optionally place a separate wager in the designated Tie Hands bet placement circle on the playing surface to bet on both player and dealer's showdown hands will attain the same total points ranking. The amount of payouts for the Tie Hands bet in the preferred payouts is eight times the amount that the player wagered.

Whilst the card game is described particularly for play as a table game in a gaming establishment, it is not limited in this respect. It may also be adapted to video play format to be played for example, in a domestic or mobile environment, electronic gaming machines, internet or in the format of a video game, slot machine, parlor game or the like. Those skilled in the art will appreciate that various modifications may be made without department from the scope of the present invention. For example, the number of standard card decks and jokers, the predetermined number of cards dealt to each player-dealer, the number of cards in a qualifying hand and a showdown hand, the predetermined qualifying numbers in the qualifying hand, the representations of the joker(s) in a hand, the payout schedule, the multiples of player's wager listed in the Bonus Bet Payout Schedule, maximum payout per hand, minimum dollar bet and maximum dollar bet may be varied without departure from the scope of the present invention. Since certain changes may be made in the present disclosure without departing from the scope of the present invention, it is intended that all matter described in the foregoing specification and shown in the accompanying drawings be interpreted as illustrative and not in a limiting sense.

1. A method of playing a card game using one or more standard deck(s) of playing cards and one or more joker(s) comprising:
placing a wager to participate in said card game;
dealing a hand consisting of predetermined number of cards to each player and dealer;
separating the cards dealt into a qualifying hand and a showdown hand;
comparing player's showdown hand ranking against the dealer's showdown hand ranking only when the player and the dealer each held a qualifying hand that meets the qualifying requirement of having the values of the cards selected add up to a total sum equals to one of a predetermined qualifying numbers.

2. The method of claim 1, wherein either dealer or the player with the highest showdown hand ranking win the bet.

3. The method of claim 1, wherein said joker(s) can be used to represent any one of a plurality of predetermined cards in the qualifying hand and showdown hand.

4. The method of claim 1, wherein the joker(s) can be used to represent card(s) having a value of three (3), six (6) or nine (9) on the qualifying hand and showdown hand.

5. The method of claim 1, wherein if the player's qualifying hand fails to meet said qualifying requirement and the dealer's qualifying hand does meet said qualifying requirement, then the player loses the wager to the dealer.

6. The method of claim 1, wherein if player's qualifying hand meets said qualifying requirement and the dealer's qualifying hand does not meet said qualifying requirement, then the dealer pays the player an amount equal to one half of the wager when the selected cards in the showdown hand add up to a total points ranking equal to a predetermined value, otherwise the dealer pays the player even money if the total points ranking of the selected cards in the showdown hand is not equal to said predetermined value.

7. The method of claim 1, wherein in the event that neither the player nor the dealer's qualifying hand meets said qualifying requirement, then the bet shall push in which case neither player nor the dealer wins the bet or wager.

8. The method of claim 1, wherein said qualifying hand is a three cards hand, said showdown hand is a two cards hand, said predetermined qualification numbers are 10, 20 or 30 and said showdown hand ranking is from one to ten with ten being the highest.

9. The method of claim 1, wherein said qualifying hand is a four cards hand, said showdown hand is a two cards hand, said predetermined qualification numbers are 10, 20, 30 or 40 and said showdown hand ranking is from one to ten with ten being the highest.

10. The method of claim 1, wherein said qualifying hand is a five cards hand, said showdown hand is a two cards hand, said predetermined qualification numbers are 10, 20, 30, 40 or 50 and said showdown hand ranking is from one to ten with ten being the highest.

11. The method of claim 1, wherein said qualifying hand is a four cards hand, said showdown hand is a three cards hand, said predetermined qualification numbers are 10, 20, 30 or 40 and said showdown hand ranking is from one to ten with ten being the highest.

12. The method of claim 1, further comprising a step of providing the player with one of more additional wagering options.

13. The method of claim 12, wherein said additional wagering option is a bonus bet option and said bonus bet option provides that:
the player is an automatic winner when said player five cards dealt is one of a plurality of predetermined standard poker hands and said player receives a predetermined winning payout even if dealer's five cards hand ranking exceeds said player's five card hand ranking.

14. The method of claim 13, wherein said Joker(s) can only be used on the bonus hand to represent a card to complete a royal flush, straight flush or straight or as an Ace to attain 5 Aces, 4 Aces (Four of A Kind), 3 Aces (Three of A Kind) or 2 Aces hand.

15. The method of claim 13, further comprising an additional bonus payout when said five cards dealt is said one of a plurality of predetermined standard poker hand, wherein said additional bonus payout is made in accordance with a scale:

| | |
|---|---|
| 5 Aces | 5000 to 1 |
| Royal Flush (No Joker) | 1000 to 1 |
| Royal Flush (With Joker) | 250 to 1 |
| Straight Flush | 100 to 1 |
| Four of a kind | 50 to 1 |
| Full house | 20 to 1 |
| Flush | 15 to 1 |
| Straight | 12 to 1 |
| Three of a kind | 10 to 1 |
| Two pair | 9 to 1 |

The maximum payout is 50,000 dollars.

16. The method of claim 12, wherein said additional wagering option is a pot bet option wherein, all players contribute to the side pot and the player having the best hand wins the side pot.

17. The method of claim 12, wherein said additional wagering option is a Tie Hands bet option wherein, in the event that neither the player nor the dealer's qualifying hand meets said qualifying requirement, then said Tie Hands bet shall push in which case neither player nor the dealer wins the Tie Hands bet or wager.

18. The method of claim 12, wherein said additional wagering option is a Tie Hands bet option wherein, in the event that both player and the dealer's qualifying hand meets said qualifying requirement and said player and dealer's showdown hands both attain the same total points ranking, then the player receives a predetermined multiple of the amount that the player wagered.

19. The method according to claim 1, wherein said method is performed by an electronic game.

20. The method according to claim 1, wherein said method is performed in conjunction with the internet.

21. The method according to claim 1, wherein said method is implemented in software.

22. The method according to claim 1, wherein said method is a casino card game.
